(19) United States
(12) Patent Application Publication
(10) Pub. No.: US 2025/0124103 A1
(43) Pub. Date: Apr. 17, 2025

(54) SYSTEMS AND METHODS FOR TRANSFORMER ATTENTION ACCELERATION BASED ON TENSOR GROUPING

(71) Applicant: QUALCOMM Incorporated, San Diego, CA (US)

(72) Inventors: Sundar SUBRAMANIAN, San Diego, CA (US); Venkata Naga Sai Ravi Teja KONDURU, San Diego, CA (US); Ramanan SEKAR, San Jose, CA (US); Soyeb Noormohammed NAGORI, San Diego, CA (US)

(21) Appl. No.: 18/909,838

(22) Filed: Oct. 8, 2024

Related U.S. Application Data
(60) Provisional application No. 63/590,178, filed on Oct. 13, 2023.

(51) Int. Cl. G06F 17/16

(52) U.S. Cl. CPC G06F 17/16

(57) ABSTRACT

Systems and techniques for attention calculation optimization are described. An attention calculation system identifies tensor dimensions based on a characteristic of a tensor multiplication engine. In some examples, the tensor dimensions are matrix dimensions, for instance if the characteristic indicates that the tensor multiplication engine is optimized for matrix multiplication. The attention calculation system groups at least a subset of query data into at least one query tensor having the tensor dimensions. The attention calculation system groups at least a subset of key data into at least one key tensor having the tensor dimensions. The attention calculation system determines, using the tensor multiplication engine, a tensor multiplication including the at least one query tensor and the at least one key tensor to generate output data.

### CROSS-REFERENCE TO RELATED APPLICATIONS

This application claims the benefit of U.S. Provisional Application No. 63/590,178, filed Oct. 13, 2023, and titled “Systems and Methods for Transformer Attention Acceleration Based on Tensor Grouping,” which is hereby incorporated by reference in its entirety and for all purposes.

### FIELD

The present disclosure generally relates to optimizing processing of data using a machine learning model based on constraints associated with artificial intelligence (AI) accelerator system(s). For example, aspects of the present disclosure relate to systems and techniques for optimizing attention calculations associated with a transformer model based on constraints associated with matrix multiplication subsystem(s) of AI accelerator system(s).

### BACKGROUND

Machine learning models are useful for a variety of tasks, including image processing, computer vision, natural language processing, and generating content. In some examples, a machine learning model can process data using multiplications of vectors, matrices, and/or other types of tensors. Processing of large amounts of data, and complex processing tasks, can often require multiplication of very large tensors and/or high quantities of tensor multiplications. Such calculations can be very computationally expensive, which can lead to high latency, high power usage, high levels of heat generation, increased resources devoted to heat dissipation, and the like.

### BRIEF SUMMARY

Systems and techniques for attention calculation optimization are described. In various aspects, an attention calculation system identifies tensor dimensions based on at least one characteristic of a tensor multiplication engine. In some examples, the tensor dimensions are matrix dimensions, for instance if the at least one characteristic indicates that the tensor multiplication engine is optimized for matrix multiplication. The attention calculation system groups at least a subset of query data into at least one query tensor having the tensor dimensions. The attention calculation system groups at least a subset of key data into at least one key tensor having the tensor dimensions. The attention calculation system determines, using the tensor multiplication engine, a tensor multiplication including the at least one query tensor and the at least one key tensor to generate output data.

According to some aspects, an apparatus for attention calculation optimization is provided. The apparatus includes: a memory; and at least one processor (e.g., implemented in circuitry) coupled to the memory and configured to: identify tensor dimensions based on at least one characteristic of a tensor multiplication engine; group a subset of query data into at least one query tensor having the tensor dimensions; group a subset of key data into at least one key tensor having the tensor dimensions; and determine, using the tensor multiplication engine, a tensor multiplication including the at least one query tensor and the at least one key tensor to generate output data.

In some aspects, a method of attention calculation optimization is provided. The method includes: identifying tensor dimensions based on at least one characteristic of a tensor multiplication engine; grouping a subset of query data into at least one query tensor having the tensor dimensions; grouping a subset of key data into at least one key tensor having the tensor dimensions; and determining, using the tensor multiplication engine, a tensor multiplication including the at least one query tensor and the at least one key tensor to generate output data.

In some aspects, a non-transitory computer-readable medium is provided that has stored thereon instructions that, when executed by one or more processors, cause the one or more processors to: identify tensor dimensions based on at least one characteristic of a tensor multiplication engine; group a subset of query data into at least one query tensor having the tensor dimensions; group a subset of key data into at least one key tensor having the tensor dimensions; and determine, using the tensor multiplication engine, a tensor multiplication including the at least one query tensor and the at least one key tensor to generate output data.

In some aspects, an apparatus for attention calculation optimization is provided. The apparatus includes: means for identifying tensor dimensions based on at least one characteristic of a tensor multiplication engine; means for grouping a subset of query data into at least one query tensor having the tensor dimensions; means for grouping a subset of key data into at least one key tensor having the tensor dimensions; and means for determining, using the tensor multiplication engine, a tensor multiplication including the at least one query tensor and the at least one key tensor to generate output data.

In some aspects, the apparatus is part of, and/or includes a wearable device, an extended reality device (e.g., a virtual reality (VR) device, an augmented reality (AR) device, or a mixed reality (MR) device), a head-mounted display (HMD) device, a wireless communication device, a mobile device (e.g., a mobile telephone and/or mobile handset and/or so-called “smart phone” or other mobile device), a camera, a personal computer, a laptop computer, a server computer, a vehicle or a computing device or component of a vehicle, another device, or a combination thereof. In some aspects, the apparatus includes a camera or multiple cameras for capturing one or more images. In some aspects, the apparatus further includes a display for displaying one or more images, notifications, and/or other displayable data. In some aspects, the apparatuses described above can include one or more sensors (e.g., one or more inertial measurement units (IMUs), such as one or more gyroscopes, one or more gyrometers, one or more accelerometers, any combination thereof, and/or other sensor).

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative aspects of the present application are described in detail below with reference to the following drawing figures:

FIG. 1 is a block diagram illustrating a process for auto-regressive decoding using an auto-regressive transformer model across N iterations, with inference graph topology including various tensor multiplications, in accordance with some examples;

FIG. 2 is a block diagram illustrating an example of a system with an encoder and decoder that can be used to process an input to generate an output, in accordance with some examples;

FIG. 3A is a block diagram illustrating an example of a process of using a transformer model to map features of a scene from image data captured by multiple cameras to a bird's-eye view (BEV) of the scene, in accordance with some examples;

FIG. 3B is a block diagram illustrating an example of a process of using a transformer model (with geometry-guided kernel transformation (GKT)) to map features of a scene from image data captured by multiple cameras to a bird's-eye view (BEV) of the scene, in accordance with some examples;

FIG. 3C is a block diagram illustrating an example of a process of using a transformer model (with grouping of queries and grouping of keys according to characteristic(s) of a tensor multiplication engine) to map features of a scene from image data captured by multiple cameras to a bird's-eye view (BEV) of the scene, in accordance with some examples;

FIG. 4 is a block diagram illustrating an example of a system with a group generation engine that groups queries and that groups keys into attention tensors based on characteristic(s) of a tensor multiplication engine, and that feeds the attention tensors into the tensor multiplication engine for tensor multiplication calculation(s) associated with attention block of a transformer model, in accordance with some examples;

FIG. 5 is a block diagram illustrating an example of a neural network that can be used for imaging, in accordance with some examples;

FIG. 6 is a flow diagram illustrating a process for attention calculation optimization, in accordance with some examples; and

FIG. 7 is a diagram illustrating an example of a computing system for implementing certain aspects described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

Machine learning models are useful for a variety of tasks, including image processing, computer vision, natural language processing, and generating content. In some examples, machine learning models can use various multiplications of tensors to process data. The multiplications of tensors can include multiplications between a vector (1-dimensional tensor) and a vector, multiplications between a matrix (2-dimensional tensor) and a vector, multiplications between a matrix and a matrix, multiplications between a vector and a tensor having more than 2 dimensions, multiplications between a matrix and a tensor having more than 2 dimensions, multiplications between a tensor having more than 2 dimensions and another tensor having more than 2 dimensions, or a combination thereof. In some examples, a machine learning model, such as a multi-head attention-based transformer model, can process data according to queries, keys, and values.

In some examples, queries can represent criteria for processing data, such as a search prompt, a generation prompt, image characteristics (e.g., image dimensions, image resolution, perspective on a scene, field of view) of an image to be generated, or question(s) about a location in a scene. In some examples, keys can represent information about the data to be processed. For instance, keys can include portions of data to be searched through according to a search prompt in the queries, portions of data to summarize or generate a response to based on a generation prompt in the queries, source images (or portions thereof) upon which an image matching a set of image characteristics (e.g., image dimensions, image resolution, perspective on a scene, field of view) in the queries is to be generated, or candidate features in a scene that could be a good fit for question(s) about a location in the scene in the queries. In some examples, values can include results of processing the data in the keys according to the criteria in the queries. For instance, values can include search results of searching through data in the keys based on a search criteria in a search prompt in the queries, a generated summary or generated response based on data in the keys and based on generation criteria in a generation prompt in the queries, a generated image of a scene (e.g., a bird's-eye view of the scene) based on image data from the keys (e.g., image data of the scene from various cameras having various perspectives of the scene) and based on image characteristics (e.g., identifying the bird's perspective of the scene and/or other characteristics such as image dimensions, image resolution, and/or field of view) in the queries, or a selection of a specific feature from a set of candidate features in a scene (from the keys) that represents a good fit for question(s) about a location in the scene (in the queries). In some examples, a trained machine learning model can perform iterative calculations to iterate keys, queries, and/or values using various tensor multiplications. For instance, in a multi-head attention-based transformer model, attention calculations can include multiplication of query tensor(s) by key tensor(s) to generate a product that can be further processed (e.g., via scaling, masking, and/or normalization) before being multiplied by value tensor(s).

Artificial intelligence (AI) accelerators are systems that are designed to be optimized for efficiently performing calculations that are commonly used in AI and machine learning (ML) algorithms, often including tensor multiplications. AI accelerators can include hardware, software, or combinations thereof. In some examples, an AI accelerator may have various characteristics that make the AI accelerator better optimized to efficiently and quickly perform certain types of tensor multiplications over other types of tensor multiplications. For instance, an AI accelerator may have a matrix multiplication engine and a vector multiplication engine, and can have more resources (e.g., in terms of hardware, software, or both) devoted to the matrix multiplication engine than to the vector multiplication engine. In some examples, the matrix multiplication engine can be limited to multiplication of matrices with other matrices. For such an AI accelerator, all else being equal, a set of calculations would be more efficient to be performed as a set of matrix multiplications than as a set of vector multiplications. Furthermore, in some cases, the tensor multiplication engine(s) of an AI accelerator are more efficient at multiplying tensor(s) that have certain size(s) and/or dimension(s). For instance, in an illustrative example, the tensor multiplication engine(s) of an AI accelerator may be most efficient at matrix multiplications of matrices having dimensions of 100×100. In such a scenario, an efficiency gain can be realized if a set of tensor multiplications to be performed as part of processing data using a machine learning model can be converted into a set of matrix multiplications of matrices having dimensions of 100×100.

Characteristics of AI accelerator(s) and tensor multiplication engine(s) that may have an impact on efficiency and/or performance can include, for instance, core unit tensor size associated with the tensor multiplication engine(s), a memory size (e.g., of Double Data Rate (DDR) memory) associated with the memory used by the AI accelerator(s) and/or the tensor multiplication engine(s), a memory bandwidth (e.g., a DDR memory bandwidth) associated with the memory used by the AI accelerator(s) and/or the tensor multiplication engine(s), a rate (e.g., maximum rate) of tensor multiplication calculations that the AI accelerator(s) and/or the tensor multiplication engine(s) can perform per unit of time, a numeric data type (e.g., a floating point number, an 8-bit integer, a 16-bit integer, a 32-bit integer, integer, a signed numeric data type, an unsigned numeric data type, or a combination thereof) that the tensor multiplication engine uses for numbers within tensors multiplied using the AI accelerator(s) and/or the tensor multiplication engine(s), a number of multiply-accumulate (MAC) operations and/or multiply-add (MAD) operations that the tensor multiplication engine(s) can perform per cycle, a number of channels or features that the tensor multiplication engine(s) can operate in at a time (e.g., in parallel), or a combination thereof.

Systems and techniques for attention calculation optimization are described. In some examples, a system (e.g., an attention calculation optimization system) identifies tensor dimensions based on at least one characteristic of a tensor multiplication engine. In some examples, the tensor dimensions are matrix dimensions, for instance if the at least one characteristic indicates that the tensor multiplication engine is optimized for matrix multiplication. In an illustrative example, the tensor dimensions can be matrix dimensions of 100×100, for instance based on 100×100 matrices representing a core unit size of the tensor multiplication engine, based on limitations of memory or memory bandwidth that are reached during tensor multiplications of tensors having larger dimensionality than 100×100 matrices, or the like. The system groups at least a subset of query data into at least one query tensor (e.g., query matrix) having the tensor dimensions (e.g., 100×100). The system groups at least a subset of key data into at least one key tensor (e.g., key matrix) having the tensor dimensions (e.g., 100×100). The system determines (e.g., calculates), using the tensor multiplication engine, a tensor multiplication including (e.g., involving) the at least one query tensor (e.g., query matrix) and the at least one key tensor (e.g., key matrix) to generate output data (e.g., to generate a product). In some examples, the output data (e.g., product) is used in further accelerator calculations, for instance including a tensor multiplication with a value tensor (e.g., grouped to have the tensor dimensions) using the tensor multiplication engine. By grouping the query data into the at least one query tensor having the tensor dimensions, and grouping the key data into the at least one key tensor having the tensor dimensions, the system improves efficiency by guiding the calculations to be performed by the tensor multiplication engine into the types of calculations that the tensor multiplication engine is most efficient at performing quickly. Further, in aspects where the system groups only a subset of the query data into the at least one query tensor, and where the system groups only a subset of the key data into the at least one key tensor, the system increases efficiency of attention calculations by avoiding calculating using the full query data and/or the full key data. For instance, in some examples, the system selects the subset of the query data, and/or selects the subset of the key data, based on geography (e.g., location(s) of feature(s) in a scene), based on attention results and/or statistics, and/or based on deformable attention options. These improvements in efficiency can also reduce overall computational cost of processing data using a transformer model, improve battery life, reduce heat generation, reduce need for heat dissipation systems, or a combination thereof.

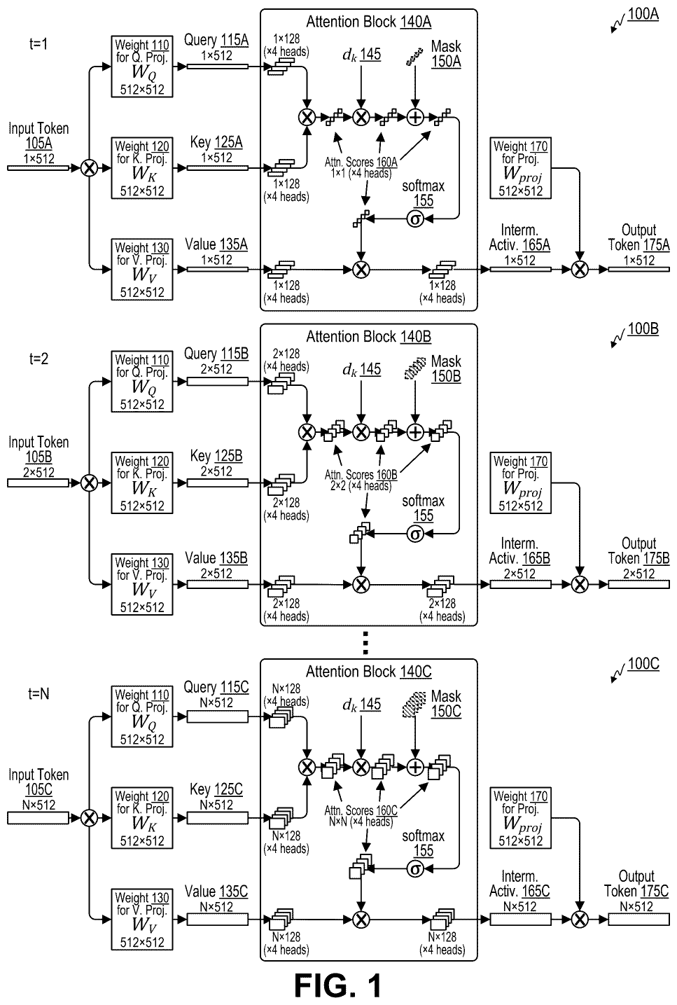

Various aspects of the application will be described with respect to the figures. FIG. 1 is a block diagram illustrating a process for auto-regressive decoding using an auto-regressive transformer model across N iterations, with inference graph topology including various tensor multiplications. In the example of FIG. 1, three iterations along the process are illustrated, with an iteration counter variable t representing the iteration number illustrated. A first iteration 100A is illustrated where t=1. A second iteration 100B is illustrated where t=2. An Nth iteration 100C is illustrated where t=N.

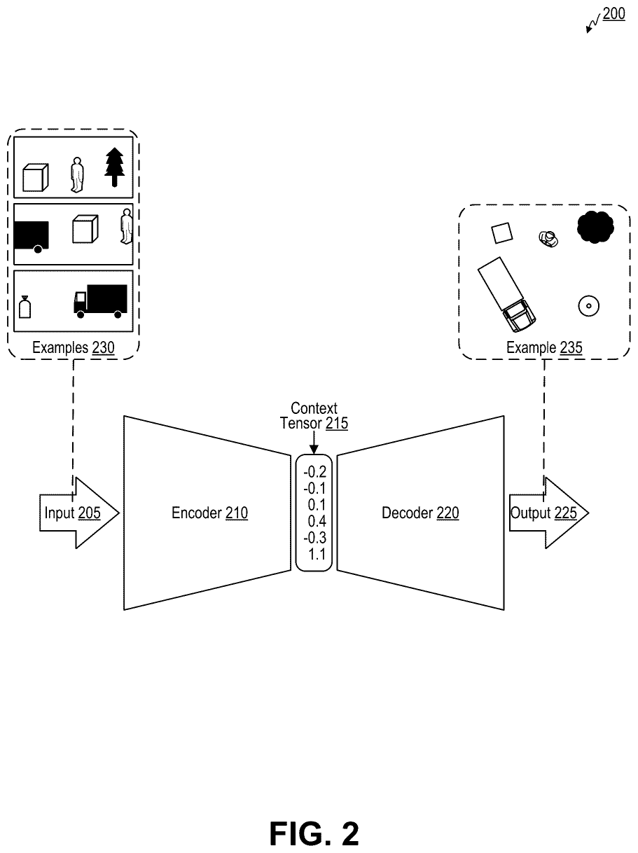

In the first iteration 100A, the iteration counter indicates that t=1, and an input token 105A is input into the auto-regressive transformer model. In the example illustrated in FIG. 1, the input token 105A is a tensor (e.g., a vector) having dimensions 1×512. Because the auto-regressive transformer model is part of a decoder (e.g., decoder 220 in FIG. 2), the input token 105A may be part of, and/or may be based on, a context tensor (e.g., context tensor 215 in FIG. 2) output by an encoder (e.g., encoder 210 in FIG. 2). In some examples, the input token 105A in the first iteration 100A is a start-of-sentence token, also referred to as a beginning-of-sentence token, a start token, a beginning token, or a combination thereof.

A set of projection tensors (e.g., projection matrices) are applied to the input token 105A using matrix multiplication and/or tensor multiplication and/or dot products. The projection tensors include a weight tensor W_{Q} 110 for query projection, a weight tensor W_{K} 120 for key projection, and a weight tensor W_{V} 130 for value projection. Applying the weight tensor W_{Q} 110 for query projection to the input token 105A (e.g., using a tensor multiplication engine) generates a query 115A, which is a tensor (e.g., vector) and/or feature having dimensions 1×512 in the example of FIG. 1. Applying the weight tensor W_{K} 120 for key projection to the input token 105A (e.g., using a tensor multiplication engine) generates a key 125A, which is a tensor (e.g., vector) and/or feature having dimensions 1×512 in the example of FIG. 1. Applying the weight tensor W_{V} 130 for value projection to the input token 105A (e.g., using a tensor multiplication engine) generates a value 135A, which is a tensor (e.g., vector) and/or feature having dimensions 1×512 in the example of FIG. 1.

In some examples, weight tensor W_{Q} 110 for query projection, the weight tensor W_{K} 120 for key projection, and/or the weight tensor W_{V} 130 for value projection are generated during training of the auto-regressive transformer model. In some examples, the auto-regressive transformer model is trained to generate these weight tensors to reduce dimensionality of the query 115A, key 125A, and value 135A tensors. In some examples, the auto-regressive transformer model is trained to generate these weight tensors to representing the relative importance of the inputs in a sequence (e.g., keys including the key 125A) for a particular output (e.g., queries including the query 115A). Multiplying the weights with the input sequence (e.g., values including the value 135A) will then weight the sequence.

The auto-regressive transformer model includes an attention block 140A that processes the query 115A, key 125A, and value 135A tensors through concatenation, matrix multiplications, linear transformations, scaling, masking, and/or normalization. For instance, the attention block 140A multiplies concatenated tensors that are based on the query 115A and the key 125A (e.g., using a tensor multiplication engine) to generate a product. The concatenated tensors can have 4 heads with dimensions 1×128 each. The attention block 140A scales the product using a scaling factor dₖ 145, for instance by dividing the product by \sqrt{dₖ}. In some examples, the query 115A, the key 125A, and/or the value 135A tensors are de-dimensional vectors whose components are variables with a mean of 0 and a variance of 1. In some examples, the product of the query 115A and the key 125A can have a mean of 0 and a variance equivalent to the scaling factor dₖ 145. Scaling the product of the query 115A and the key 125A using the scaling factor dₖ 145 (e.g., dividing the product by \sqrt{dₖ}) can keep the mean of the product at 0 and bring the variance of the product to 1.

In some examples, the attention block 140A of the auto-regressive transformer model includes a mask 150A. The mask 150A can be added (e.g., using an adder) to the product of the query 115A and the key 125A (e.g., after the scaling discussed above) to confine the attention span to only valid portion(s) of data (e.g., to remove portion(s) of the product or scaled product associated with invalid data). The attention block 140A of the auto-regressive transformer model includes a softmax function a 155 that can normalize the product (e.g., the scaled and/or masked product). The attention block 140A of the auto-regressive transformer model multiplies a concatenated variant of the value 135A (e.g., concatenated tensors having 4 heads with dimensions 1×128 each) with the scaled, masked, and/or normalized product (e.g., using a tensor multiplication engine) to generate tensor(s) (e.g., having 4 heads with dimensions 1×128 each) that can be combined into an intermediate activation tensor 165A with dimensions 1×512. In some examples, the various tensors produced in the attention block 140A can be referred to as attention scores 160A and/or intermediate activations and can have 4 heads with dimensions 1×1 each, as does the mask 150A. In some examples, the auto-regressive transformer model applies a weight tensor Wₚᵣₒⱼ 170 for projection to the intermediate activation tensor 165A (e.g., using a tensor multiplication engine) to generate an output token 175A with dimensions 1×512. In some examples, the output token 175A can represent a predicted token, for instance a predicted next word, set of one or more characters, phrase, or the like.

In the second iteration 100B, the iteration counter indicates that t=2, and an input token 105B is input into the auto-regressive transformer model. In the example illustrated in FIG. 1, the input token 105B is a tensor (e.g., a vector) having dimensions 2×512. In some examples, the input token 105B has dimensions 2×512 because the input token 105B includes the input token 105A (e.g., a start of sentence token) and the output token 175A from the first iteration 100A. This way, the second iteration 100B includes all of the context up to this point. Because each of these have dimensions 1×512, the dimensions of the input token 105B are 2×512. Because the dimensions of the input token 105B are 2×512, the dimensions of query 115B, key 125B, and value 135B are also 2×512. Similarly, attention scores 160B have 4 heads with dimensions 2×2 each, as does mask 150B. Attention block 140B outputs an intermediate activation tensor 165B with dimensions 2×512. The auto-regressive transformer model applies the weight tensor Wₚᵣₒⱼ 170 for projection to the intermediate activation tensor 165B (e.g., using a tensor multiplication engine) to generate an output token 175B with dimensions 2×512. The output token 175B can represent a predicted token, for instance a predicted next word, set of one or more characters, phrase, or the like.

In the N^{th} iteration 100C, the iteration counter indicates that t=N, and an input token 105C is input into the auto-regressive transformer model. In the example illustrated in FIG. 1, the input token 105C is a tensor (e.g., a vector) having dimensions N×512. In some examples, the input token 105C has dimensions N×512 because the input token 105C includes the input token 105A (e.g., a start of sentence token), the output token 175A from the first iteration 100A, the output token 175B from the second iteration 100B, and/or any other output tokens of any iterations in between the second iteration 100B and the N^{th} iteration 100C (e.g., a third iteration where t=3, a fourth iteration where t=4, and so forth). This way, the N^{th} iteration 100C includes all of the context up to this point. Because of this, the dimensions of the input token 105C are N×512. Because the dimensions of the input token 105C are N×512, the dimensions of query 115N, key 125N, and value 135N are also N×512. Similarly, attention scores 160C have 4 heads with dimensions N×N each, as does mask 150N. Attention block 140C outputs an intermediate activation tensor 165C with dimensions N×512. The auto-regressive transformer model applies the weight tensor Wₚᵣₒⱼ 170 for projection to the intermediate activation tensor 165C (e.g., using a tensor multiplication engine) to generate an output token 175C with dimensions N×512. The output token 175C can represent a predicted token, for instance a predicted next word, set of one or more characters, phrase, or the like. In some cases, the output token 175C can represent an end of sentence or another type of end token.

As illustrated in FIG. 1 and described above, the attention blocks 140A-140C of the auto-regressive transformer model of FIG. 1 include numerous tensor multiplications, including between each query (e.g., of the queries 115C) and each corresponding key (e.g., of the keys 125A-125C), with a mask (e.g., of the masks 150A-150C), and with a corresponding value (e.g., of the values 135A-135C). The auto-regressive transformer model of FIG. 1 as a whole includes further tensor multiplications, for instance involving the input tokens 105A-105C, the weight tensor W_{Q} 110 for query projection, the weight tensor W_{K} 120 for key projection, the weight tensor W_{V} 130 for value projection, the interim activations 165A-165C, and/or the weight tensor Wₚᵣₒⱼ 170 for projection. Because of the iterative nature of these calculations, any efficiency gain in any of these calculations can result in a significant efficiency gain in overall use of the auto-regressive transformer model of FIG. 1 for processing data.

FIG. 2 is a block diagram illustrating an example of a system 200 with an encoder 210 and decoder 220 that can be used to process an input 205 to generate an output 225. The auto-regressive transformer model of FIG. 1 are examples of the decoder 220. In some examples, an auto-regressive transformer model can include the encoder 210, the decoder 220, or a combination thereof.

The encoder 210 and decoder 220 can each be at least a portion of, or can each include, at least one machine learning model. The at least one machine learning model can include, for instance, at least one neural network (NN), at least one convolutional neural network (CNN), at least one time delay neural network (TDNN), at least one deep network (DN), at least one autoencoder (AE), at least one variational autoencoder (VAE), at least one deep belief net (DBN), at least one recurrent neural network (RNN), at least one Long Short-Term Memory (LSTM), at least one Gated Recurrent Unit (GRU), at least one generative adversarial network (GAN), at least one conditional generative adversarial network (cGAN), at least one feed-forward network, at least one network having fully connected layers, at least one trained support vector machine (SVM), at least one trained random forest (RF), at least one computer vision (CV) system, at least one autoregressive (AR) model, at least one Sequence-to-Sequence (Seq2Seq) model, at least one large language models (LLM), at least one deep learning system, at least one classifier, at least one transformer, or at least one combination thereof. In examples where the at least one machine learning model includes at least one LLM, the at least one LLM can include, for instance, a Generative Pre-Trained Transformer (GPT) (e.g., GPT-2, GPT-3, GPT-3.5, GPT-4, etc.), DaVinci or a variant thereof, an LLM using Massachusetts Institute of Technology (MIT)® langchain, Pathways Language Model (PaLM), Large Language Model Meta® AI (LLaMA), Language Model for Dialogue Applications (LaMDA), Bidirectional Encoder Representations from Transformers (BERT), Falcon (e.g., 40B, 7B, 1B), Orca, Phi-1, StableLM, variant(s) of any of the previously-listed LLMs, or a combination thereof.

In some examples, the input 205 includes a first string of text, and the output 225 includes a second string of text. In some examples, the output 225 is conversationally responsive to the input 205, for instance as in a chatbot, a virtual assistant, a search engine, or a combination thereof. In some examples, the output 225 is a translation of the input 205 from a first language of the input 205 to a second language of the output 225, as in a neural machine translation (NMT) system. In some examples, the encoder 210 processes the input 205 to generate a context tensor 215, also referred to as a thought tensor, a context vector, a though vector, a context matrix, or a thought matrix. In an illustrative example, the encoder 210 includes an RNN, and the context tensor 215 is the output (e.g., final state) of the RNN. The context tensor 215 is input to the decoder 220. For instance, in some examples, the input tokens 105A-105C (FIG. 1) can be retrieved from, and/or based on, the context tensor 215 output by the encoder 210. The output 225 can include, and/or be based on, the output tokens 175A-175C (FIG. 1).

In some examples, the input 205 includes one or more images of a scene captured from one or more perspectives, and the output 225 includes a generated image of the scene from a second perspective that is different from any of the one or more perspectives. For instance, the one or more images of the scene in the input 205 can be captured by one or more cameras having the one or more perspectives on the scene, while the generated image of the scene in the output 225 can have a bird's eye view (BEV) perspective, which can also be referred to as a top-down perspective, on the scene. In some examples, the encoder 210 processes the input 205 to generate a context tensor 215 that is associated with features to be converted from the one or more perspectives associated with the input 205 to the second perspective associated with the output 225. Examples 230 of three images of a scene are illustrated as associated with the input 205. An example 235 of a BEV of the same scene is illustrated as associated with the output 225.

In some examples, the auto-regressive transformer models of FIG. 1 can be used for the encoder 210 instead of or in addition to the decoder 220. For instance, in some examples, the input tokens 105A-105C (FIG. 1) can be retrieved from, and/or based on, the input 205. In such cases, the context tensor 215 can include, and/or be based on, the output tokens 175A-175C.

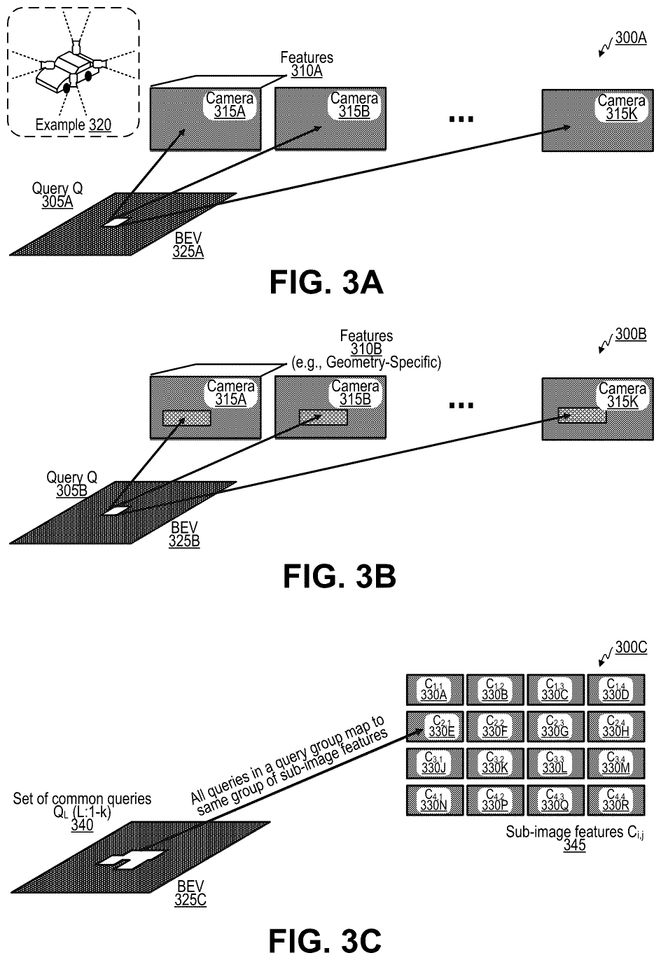

FIG. 3A is a block diagram illustrating an example of a process 300A of using a transformer model to map features of a scene from image data captured by multiple cameras 315A-315K to a bird's-eye view (BEV) 325A of the scene. The neural architecture of a transformer model includes an attention mechanism between queries and keys, for instance as illustrated in the attention blocks 140A-140C of FIG. 1. Attention between all queries and all keys can be referred to as global attention.

An example of a use case of a transformer model is illustrated in FIG. 3A. A row of shaded rectangles represent image data, and/or features 310A therein, from cameras 315A-315K. The cameras 315A-315K include a first camera 315A, a second camera 315B, and potentially more cameras, up to a Kth camera 315K. The image data captured by the cameras 315A-315K can be image data of a scene (e.g., depicting the scene). An example 320 of a vehicle with four cameras coupled to the vehicle is illustrated as part of FIG. 3A, with each of the cameras in the example 320 having different perspectives of the scene around the vehicle. The four cameras in the example 320 can represent examples of the cameras 315A-315K.

In the use case illustrated in FIG. 3A, the transformer model is used to generate the bird's eye view (BEV) 325A of the scene based on features 310A in the image data from the cameras 315A-315K. The BEV 325A of the scene is depicted as a shaded parallelogram that may actually represent a square BEV 325A or rectangular BEV 325A of the scene, and transformation of the features 310A in the image data from the cameras 315A-315K into a different perspective (the BEV 325A perspective). A query Q 305A is illustrated as a highlighted region (e.g., square or rectangle) of the BEV 325A. The query Q 305A is illustrated as a parallelogram, but can represent a square or rectangular area of the BEV 325A of the scene.

In some examples, the query Q 305A represents question(s) about a location in the BEV 325A representation of the scene. In some examples, key(s) can represent candidate features in a scene (e.g., of the features 310A of the image data from the cameras 310A-310K) that could be a good fit for question(s) in the query Q 305A about the location in the BEV 325A representation of the scene. In some examples, key(s) can represent a selection of one or more of the candidate features in the scene (e.g., selected from the key(s)) that represents a good fit for question(s) in the query Q 305A about the location in the BEV 325A representation of the scene. In some examples, the transformer model represents a pointwise transformation that determines correspondence between two-dimensional (2D) positions of the features 310A in the image(s) (e.g., 2D images) captured by the cameras 310A-310K, and BEV versions of those features 310A along a 2D plane (e.g., 2D grid) of the BEV 325A of the scene. In some examples, transformer model(s) that performs a transformation from features 310A from one or more views (e.g., one or more perspectives of the cameras 310A-310K) to corresponding features in a different view or perspective (e.g., the BEV 325A) can be referred to as cross-view transformer(s) (CVT).

In some examples, global attention calculations between every query for the BEV 325A (e.g, query Q 305A) and every key (e.g., every feature 310A of every image captured by all of the cameras 310A-310K) in a transformer model can be computationally expensive, in some cases including large numbers of multiplications between very large tensors. In an illustrative example, the grid size of the 2D grid representing the BEV 325A of the scene may have dimensions of 64×64 grid segments, a total of 4096 total grid segments, with each grid segment representing a query (e.g., query Q 305A). If the number of cameras K is 6, and each image from each camera includes 5000 pixels and/or features, then the keys would include 6×5000=30000 data elements. A tensor multiplication of a query tensor with 4096 elements multiplied by a key tensor with 30000 elements, as would be performed under global attention for CVT, can be computationally expensive, especially when the transformer model performs such calculations every time the cameras 310A-310K capture a new set of images, and especially in iterative transformer model implementations as illustrated in FIG. 1. In some cases, a system (e.g., AI accelerator or tensor multiplication engine thereof) performing such large tensor multiplications may break up each such large tensor multiplication into multiple smaller matrix multiplications that the system then combines to get the full result of the tensor multiplication. For instance, if a core unit tensor size of the tensor multiplication engine of the AI accelerator is 100×100 matrices, the 4096-element tensor and the 30000-element tensor can be broken up into numerous 100×100 matrices which the AI accelerator can multiple iteratively and combine to calculate the full tensor multiplication. This can result in significant back-and-forth in memory, heavy usage of computational resources generally, and significant time to evaluate one set of images representing the scene at one point in time (e.g., that can cause latency, lag, and/or delay in generating the BEV 325A of the scene). Certain contexts, such as vehicular contexts (e.g., generating the BEV of a scene around a vehicle based on image data from camera(s) coupled to the vehicle for use in navigation of the vehicle), can have latency deadlines, which can require the system to generate the BEV 325A of the scene within a specified amount of time to allow the vehicle's navigation system to use the BEV 325A in navigation, as the BEV 325A may be out-of-date after that specified amount of time.

In some examples, the amount, and tensor size, of CVT calculations can be reduced based on feature geometry as illustrated in FIG. 3B. This reduction can be referred to as geometry-guided kernel transformation (GKT).

FIG. 3B is a block diagram illustrating an example of a process 300B of using a transformer model (with geometry-guided kernel transformation (GKT)) to map features of a scene from image data captured by multiple cameras 315A-315K to a bird's-eye view (BEV) 325B of the scene. The process 300B includes selecting subset(s) of the image data (e.g., of the features 310B) from the cameras 310A-310K based on a location of the query (e.g., query Q 305B) in the 2D plane of the BEV 325B of the scene, thus reducing the attention to those subsets. For instance, in some examples, for a given query Q 305B representing an area in the 2D plane of the BEV 325B of the scene, in some examples, a projection engine projects (e.g., using three-dimensional (3D) geometric transformations and/or 3D projections) the location of the query Q 305B from the 2D plane of the BEV 325B to the perspective(s) of each of the cameras 310A-310K. The subset of features 310B and/or image data can include the projected location and an area in the proximity (e.g., within a radius of a predetermined size) around the projected location. In some examples, the projection engine projects (e.g., using 3D geometric transformations and/or 3D projections) the location of the features in image data from the perspective(s) of each of the cameras 310A-310K to the perspective of the 2D plane of the BEV 325B.

One benefit of the process 300B is that the sizes of the tensor multiplications are reduced compared to the process 300A. However, one downside of the process 300B is that a number of the tensor multiplications used in the process 300B are vector×matrix multiplications. In some examples, an AI accelerator may have various characteristics that make the AI accelerator better optimized to efficiently and quickly perform certain types of tensor multiplications over other types of tensor multiplications. For instance, an AI accelerator may have a matrix multiplication engine and a vector multiplication engine, and can have more resources (e.g., in terms of hardware, software, or both) devoted to the matrix multiplication engine than to the vector multiplication engine. In some examples, the matrix multiplication engine can be limited to multiplication of matrices with other matrices, with the less efficient vector multiplication engine used for any tensor multiplication calculation involving a vector. Thus, the process 300B can still include some inefficiencies when performed using such an AI accelerator, in that the AI accelerator is forced to use the less efficient vector multiplication engine for the vector×matrix multiplications of the process 300B rather than being able to use the more efficient matrix multiplication engine. From this perspective, the process 300A has an advantage over the process 300B, in that the tensor multiplications of the process 300A are matrix×matrix multiplications that can be calculated using the more efficient matrix multiplication engine of the AI accelerator.

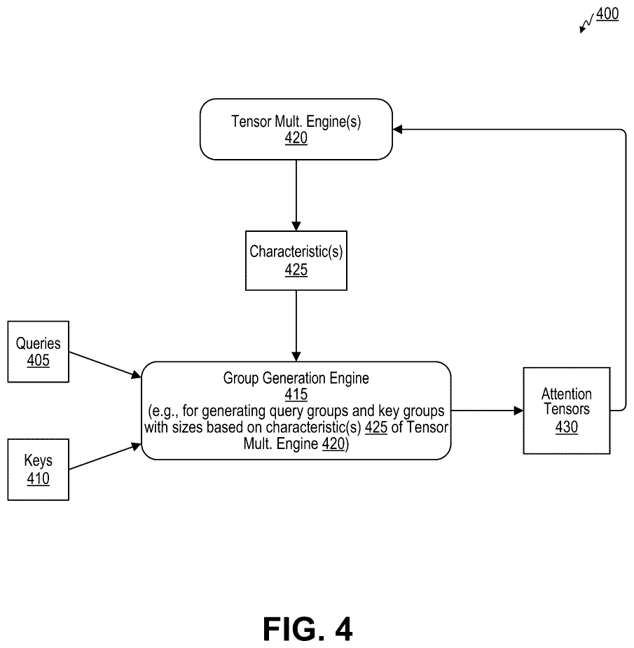

FIG. 3C is a block diagram illustrating an example of a process 300C of using a transformer model (with grouping of queries and grouping of keys according to characteristic(s) of a tensor multiplication engine) to map features of a scene from image data captured by multiple cameras to a bird's-eye view (BEV) 325C of the scene. In the process 300C, a group generation engine (e.g., group generation engine 415 of FIG. 4), which can also be referred to as a group generator or a group selector, can identify a set of tensor dimensions that are optimal for a tensor multiplication engine(s) of an AI accelerator based on certain characteristics of the tensor multiplication engine and/or the AI accelerator. The group generation engine groups query data into query tensors and key data into key tensors, with the query tensors and the key tensors having dimensions matching the set of tensor dimensions that the group generation engine determined to be optimal for the tensor multiplication engine(s) of the AI accelerator.

For instance, in an illustrative example, the tensor multiplication engine(s) of an AI accelerator are most efficient at matrix multiplications of matrices having dimensions of 100×100. In such a scenario, an efficiency gain can be realized under the process 300C by having the group generation engine group the query data into query tensors (query matrices) having dimensions of 100×100, and by having the group generation engine group the key data into key tensors (key matrices) having dimensions of 100×100.

In FIG. 3C, sub-image features C_{i,j} 345 are illustrated and represent keys, rather than the cameras 315A-315K and their corresponding image data being illustrated as in FIG. 3A and FIG. 3B. In some examples, the sub-image features C_{i,j} 345 can be from one of the images captured by one of the cameras 315A-315K, with the process 300C iterated for sub-image features C_{i,j} of a different one of the images captured by one of the cameras 315A-315K (e.g., a different one of the cameras 315A-315K than before). In some examples, the sub-image features C_{i,j} 345 can be from images captured by multiple cameras of the cameras 315A-315K. The sub-image features C_{i,j} 345 include sub-image features C_{1,1} 330A, sub-image features C_{1,2} 330B, sub-image features C_{1,3} 330C, sub-image features C_{1,4} 330D, sub-image features C_{2,1} 330E, sub-image features C_{2,2} 330F, sub-image features C_{2,3} 330G, sub-image features C_{2,4} 330H, sub-image features C_{3,1} 330J, sub-image features C_{3,2} 330K, sub-image features C_{3,3} 330L, sub-image features C_{3,4} 330M, sub-image features C_{4,1} 330N, sub-image features C_{4,2} 330P, sub-image features C_{4,3} 330Q, and sub-image features C_{4,4} 330R. In some examples, each set of sub-image features C_{i,j} 345 can have dimensions matching the set of tensor dimensions that are determined by the group generation engine to be optimal for the tensor multiplication engine(s) of the AI accelerator. It should be understood that the sub-image features C_{i,j} 345 need not be a partition, and can have overlap.

In some examples, to perform the grouping of a subset of the query data into a query tensor (e.g., a query matric) and the grouping of a subset of the key data into a key tensor (e.g., a key matrix), the group generation engine can break down the 2D plane grid of the BEV 325C of the scene into a set of common queries Q_{L} 340 (e.g., where L ranges from 1 to k) with common keys (e.g., a common group of the sub-image features C_{i,j} 345). For instance, the set of common queries Q_{L} 340 that is illustrated in FIG. 3C all map to the sub-image features C_{2,1} 330E of the sub-image features C_{i,j} 345. Like the process 300B, the group generation engine of the process 300C can reduce attention by only performing tensor multiplication associated with a subset of query data (e.g., the set of common queries Q_{L} 340 being a subset of the BEV 325C) and a subset of the key data (e.g., the sub-image features C_{2,1} 330E or any of the other sub-image features C_{i,j} 345 representing a subset of the set of all features).

Similarly to the process 300B, the process 300C provides an improvement over the process 300A in that only a subset of the queries and keys are processed, rather than the global attention of the process 300A. However, on top of this improvement, the process 300C also adds another improvement by optimizing for the AI accelerator and/or tensor multiplication engine. For instance, the process 300C groups the subset of the query data into a query tensor (e.g., query matrix) with tensor dimensions matching the set of tensor dimensions that the group generation engine determined to be optimal for the tensor multiplication engine(s) of the AI accelerator, and the process 300C groups the subset of the key data into a key tensor (e.g., key matrix) with tensor dimensions matching the set of tensor dimensions that the group generation engine determined to be optimal for the tensor multiplication engine(s) of the AI accelerator. These two improvements, together, can provide a significant reduction of computational resource usage, memory (e.g., DDR memory) usage, memory (e.g., DDR memory) bandwidth usage, latency, heat generation, and need for resources devoted to heat dissipation, or a combination thereof. In an illustrative example, use of the process 300C can result in an approximately 16× reduction in computational resource usage compared to use of the process 300A.

In some examples, the process 300B has a constant C keys per query, making the computational load proportional to the queries alone. However, this ends up resulting in use of vector multiplication engines rather than matrix multiplication engines, with can be less optimized in certain AI accelerators, and can thus be less efficient than the process 300C. The process 300C reduces computational load but can keep query×key tensor multiplications in matrix×matrix form, and with dimensions that match the capabilities of the AI accelerator, overall improving efficiency of the process 300C by leaning into the strengths of the AI accelerator.

FIG. 4 is a block diagram illustrating an example of a system 400 with a group generation engine 415 that groups queries 405 and that groups keys 410 into attention tensors 430 based on characteristic(s) 425 of a tensor multiplication engine 420, and that feeds the attention tensors 430 into the tensor multiplication engine 420 for tensor multiplication calculation(s) associated with attention block of a transformer model. In some examples, the system 400 perform the process 300C.

The group generation engine 415 receives one or more characteristic(s) 425 of one or more tensor multiplication engine(s) 420 of one or more AI accelerator(s). The tensor multiplication engine(s) 420, and the AI accelerator(s), can each include hardware, software, or a combination thereof. The generation engine 415 identifies, based on the characteristic(s) 425 of the tensor multiplication engine(s) 420, a set of tensor dimensions that the group generation engine 415 determines to be optimal for the tensor multiplication engine(s) 420 of the AI accelerator. The set of tensor dimensions can include an identification of dimensionality of one or both tensors involved in a tensor multiplication. For instance, in an illustrative example, one of the characteristic(s) 425 of the tensor multiplication engine(s) 420 can be that the tensor multiplication engine(s) 420 is more efficient at matrix multiplication (e.g., matrix×matrix) than at tensor multiplications involving vectors (e.g., vector×vector, vector×matrix, or vector×high-dimensionality tensor) or tensor multiplication involving high-dimensionality tensors with more than 2 dimensions (e.g., high-dimensionality tensor×vector, high-dimensionality tensor×matrix, high-dimensionality tensor×high-dimensionality tensor). In some examples, the characteristic(s) 425 can indicate a maximum size for tensor(s) for optimality for the tensor multiplication engine(s) 420, for instance including one or more maximum dimensions (e.g., a maximum length and/or a maximum width). In some examples, the some examples, the characteristic(s) 425 can indicate a core tensor unit size for tensor(s) of the tensor multiplication engine(s) 420, for instance indicating what core tensor unit size the tensor multiplication engine(s) 420 breaks larger tensors into. In some examples, the set of tensor dimensions that are optimal for the tensor multiplication engine(s) 420 can match the core tensor unit size for tensor(s) of the tensor multiplication engine(s) 420, so that the sizes of the tensors are maximized without the tensors having to be broken down further by the tensor multiplication engine(s) 420. In some examples, the core tensor unit size for tensor(s) of the tensor multiplication engine(s) 420 can be used as the one or more maximum dimensions. In some examples, the set of tensor dimensions can be based on what tensor size can fit in an amount of memory (e.g., DDR memory) that is available to the tensor multiplication engine(s) 420. In some examples, the set of tensor dimensions can be based on what tensor size can fit in a bandwidth for memory (e.g., DDR memory) that is available to the tensor multiplication engine(s) 420.

In some examples, the characteristic(s) 425 include, for instance, core unit tensor size associated with the tensor multiplication engine(s), a memory size (e.g., of Double Data Rate (DDR) memory) associated with the memory used by the AI accelerator(s) and/or the tensor multiplication engine(s), a memory bandwidth (e.g., a DDR memory bandwidth) associated with the memory used by the AI accelerator(s) and/or the tensor multiplication engine(s), a rate (e.g., maximum rate) of tensor multiplication calculations that the AI accelerator(s) and/or the tensor multiplication engine(s) can perform per unit of time, a numeric data type (e.g., a floating point number, an 8-bit integer, a 16-bit integer, a 32-bit integer, integer, a signed numeric data type, an unsigned numeric data type, or a combination thereof) that the tensor multiplication engine uses for numbers within tensors multiplied using the AI accelerator(s) and/or the tensor multiplication engine(s), a number of multiply-accumulate (MAC) operations and/or multiply-add (MAD) operations that the tensor multiplication engine(s) can perform per cycle, a number of channels or features that the tensor multiplication engine(s) can operate in at a time (e.g., in parallel), or a combination thereof.

The group generation engine 415 receives queries 405 (e.g., data representing the BEV 325C of FIG. 3C) and keys 410 (e.g., data representing the sub-image features C_{i,j} 345 of the images of the cameras 315A-315K). The group generation engine 415 selects a subset of the queries 405 to group together into a query group, for instance selecting the set of common queries Q_{L} 340 as illustrated in FIG. 3C. The group generation engine 415 selects a subset of the keys 410 to group together into a key group, for instance selecting the sub-image features C_{2,1} 330E as illustrated in FIG. 3C. The query group can be referred to as a query tensor (e.g., a query matrix or a query vector in some cases depending on the dimensionality) and has dimensions matching the set of tensor dimensions that the group generation engine 415 determined to be optimal for the tensor multiplication engine(s) 420 of the AI accelerator, based on the characteristic(s) 425. The key group can be referred to as a key tensor (e.g., a key matrix or a key vector in some cases depending on the dimensionality) and has dimensions matching the set of tensor dimensions that the group generation engine 415 determined to be optimal for the tensor multiplication engine(s) 420 of the AI accelerator, based on the characteristic(s) 425.

In some examples, the group generation engine 415 selects the query group (e.g., query tensor) and/or the key group (e.g., key tensor) based on geometry-based criteria. For instance, in some examples, the group generation engine 415 groups a subset of the queries 405 that are close or proximate to each other (e.g., within a predetermined radius of one another) to be included in the query group. In some examples, the group generation engine 415 uses a 3D projection based on the selected query group to identify which subset of the keys 410 corresponds to the queries in the query group. In some examples, the group generation engine 415 groups a subset of the keys 410 that are close or proximate to each other (e.g., within a predetermined radius of one another) to be included in the key group. In some examples, the group generation engine 415 uses a 3D projection based on the selected key group to identify which subset of the queries 405 corresponds to the keys in the key group.

In some examples, for a given query Q of the queries 405 (e.g., representing a location or area in a BEV of a scene), in some examples, a projection engine projects (e.g., using 3D geometric transformations and/or 3D projections) the location of the query Q from the 2D plane of the BEV of the scene to the perspective(s) of one or more images of the scene captured by one or more cameras, with the resulting locations representing features to be selected in the key group by the group generation engine 415. In some examples, the key group can include the projected location and an area in the proximity (e.g., within a radius of a predetermined size) around the projected location. In some examples, the projection engine projects (e.g., using 3D geometric transformations and/or 3D projections) the location of the features from the keys 410 (e.g., from the perspective(s) of one or more images of the scene captured by one or more cameras) to the queries 405 (e.g., to the perspective of the 2D plane of the BEV of the scene).

In some examples, the group generation engine 415 selects the query group (e.g., query tensor) and/or the key group (e.g., key tensor) based on attention-based criteria. For instance, the group generation engine 415 can select the query group and/or key group based on attention results themselves, for instance based on previous data in previous iterations (e.g., previous queries of the queries 115A-115N, previous keys of the keys 125A-125N, previous values of the values 135A-135N, and/or previous output tokens of the output tokens 175A-175C) as in FIG. 1. In some examples, the correlation between certain attention results and certain queries and/or keys can be determined and/or predicted using an offline machine learning model and/or offline statistics-based grouping to select based on attention-based criteria. In an illustrative example, keys C5, C10, and C15 can be selected based on having a high correlation with attention results A1, A7, and A16, respectively. The keys C5, C10, and C15 can be examples of three of the features 310A, three of the features 310B, three of the sub-image features C_{i,j} 345, and/or three of the keys 410. Attention results A1, A7, and A16 can be examples of the results of any of the attention blocks 140A-140C, the attention tensors 430, other attention results discussed herein, or a combination thereof.

In some examples, the group generation engine 415 selects the query group (e.g., query tensor) and/or the key group (e.g., key tensor) based on deformable attention options. Deformable attention options can refer to determining one or more offsets, for instance offsets that may be important to nearby tiles of the BEV. For instance, for each query, the relevant keys (e.g., camera features) may be determined via offsets determining which tiles of the BEV are relevant. The grouping can determine which queries have common tiles. In some examples, deformable attention options can be used to identify the top N most relevant (e.g., most common) tiles, features, and/or keys.

In some examples, the group generation engine 415 selects the query group (e.g., query tensor) and/or the key group (e.g., key tensor) based on a combination of geometry-based criteria, attention-based criteria, and/or deformable attention options. For instance, the geometry-based criteria can limit the area that the group generation engine 415 selects queries and/or keys from, and the attention-based criteria or the deformable attention options can limit the selection of the queries and/or keys further.

The term attention tensors 430 can refer to both query groups and key groups as grouped by the group generation engine 415.

In an illustrative example, the characteristic(s) 425 may identify that the tensor multiplication engine(s) 420 are capable of 16,000 multiply-accumulate (MAC) operations and/or multiply-add (MAD) operations per cycle. The characteristic(s) 425 may identify that the tensor multiplication engine(s) 420 can use a core unit tensor size of a 100×100 matrix. The characteristic(s) 425 may identify that the tensor multiplication engine(s) 420 can calculate using 32 channels or features at a time (e.g., in parallel). In some examples, the group generation engine 415 can select the attention tensors 430 (e.g., the query groups and the key groups) to have dimensions that are tileable using matrices with dimensions 100×100, for instance being a multiple of the core unit tensor size (100×100) or a fraction of the core unit tensor size (100×100). In some examples, the group generation engine 415 can select the attention tensors 430 (e.g., the query groups and the key groups) to have dimensions of 100×100.

Once the group generation engine 415 generates the attention tensors 430 (e.g., the query groups and the key groups), the group generation engine 415 passes the attention tensors 430 on to the tensor multiplication engine(s) 420 to perform tensor multiplication(s) using the attention tensors 430.

In some examples, one query group (e.g., query tensor) can be selected by the group generation engine 415 to include at least one overlapping query data element with another query group, for instance to provide some continuity between tiles of the BEV. Similarly, one key group (e.g., key tensor) can be selected by the group generation engine 415 to include at least one overlapping key data element with another key group, for instance to provide some continuity between tiles of the BEV

As discussed with respect to FIG. 3C, the system 400 provides an improvement over the process 300A in that only a subset of the queries and keys are processed, rather than the global attention of the process 300A. On top of this improvement, the system 400 also adds another improvement by optimizing for the AI accelerator and/or tensor multiplication engine, for instance by having the dimensions of the attention tensors 430 match the set of tensor dimensions that the group generation engine 415 determined to be optimal for the tensor multiplication engine(s) 420 of the AI accelerator based on the characteristic(s) 425 of the tensor multiplication engine(s) 420. These two improvements, together, can provide a significant reduction of computational resource usage, memory (e.g., DDR memory) usage, memory (e.g., DDR memory) bandwidth usage, latency, heat generation, and need for resources devoted to heat dissipation, or a combination thereof. In an illustrative example, use of the system 400 can result in an approximately 16× reduction in computational resource usage compared to use of the process 300A.

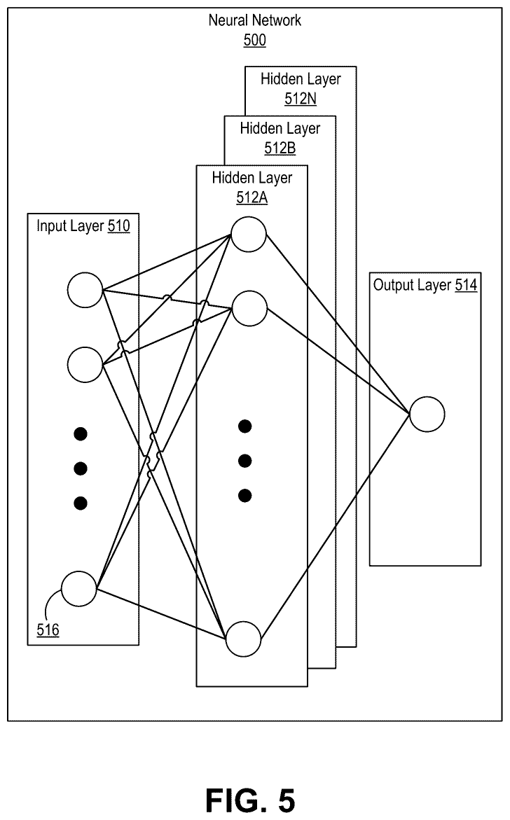

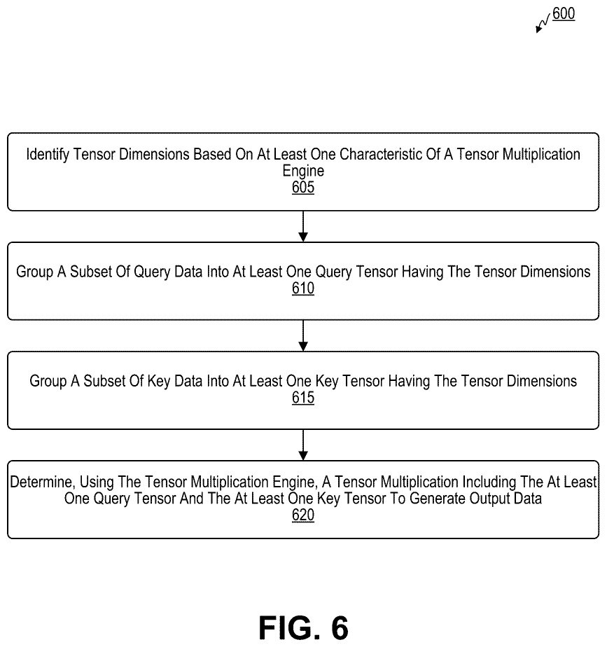

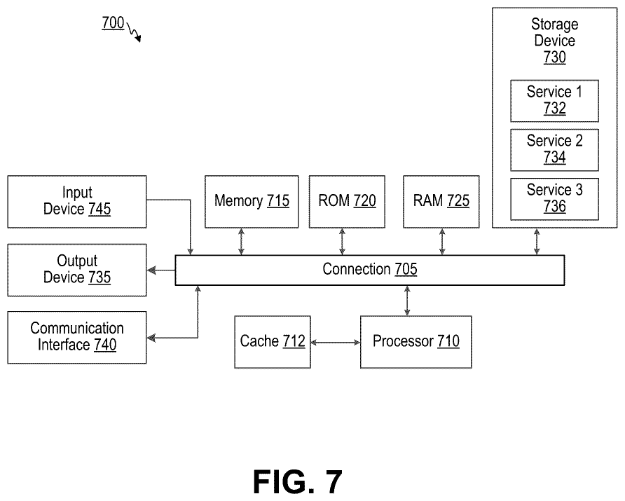

FIG. 5 is a block diagram illustrating an example of a neural network (NN) 500 that can be used for imaging operations. The neural network 500 can include any type of deep network, such as a convolutional neural network (CNN), an autoencoder, a deep belief net (DBN), a Recurrent Neural Network (RNN), a Generative Adversarial Networks (GAN), an auto-regressive transformer models, and/or other type of neural network. The neural network 500 may be an example of one of the auto-regressive transformer model of FIG. 1, the weight tensor W_{Q} 110 for query projection of FIG. 1, the weight tensor W_{K} 120 for key projection of FIG. 1, the weight tensor W_{V} 130 for value projection of FIG. 1, the attention blocks 140A-140C of FIG. 1, the weight tensor Wₚᵣₒⱼ 170 for projection of FIG. 1, the system 200 of FIG. 2, the encoder 210 of FIG. 2, the decoder 220 of FIG. 2, the system 400 of FIG. 4, the group generation engine 415 of FIG. 4, the tensor multiplication engine(s) 420 of FIG. 4, a machine learning model that performs at least one of the operations 605-620 of the process 600 of FIG. 6, a machine learning model that runs on the computing system 700 of FIG. 7, or a combination thereof.

An input layer 510 of the neural network 500 includes input data. The input data of the input layer 510 can include data representing an input token, such as one of the input tokens 105A-105C (FIG. 1). The input data of the input layer 510 can include data from, or based on, the context tensor 215 output by the encoder 210 (FIG. 2). The input data of the input layer 510 can include data from, or based on, the input 205 (FIG. 2). In some examples, the input data of the input layer 510 includes at least one input token (e.g., input tokens 105A-150C), at least one query (e.g., queries 115A-115C, query Q 305A, query Q 305B, set of common queries Q_{L} 340, queries 405, query data of operation 610), at least one key (e.g., keys 125A-125C, features 310A-310B, key data from the cameras 315A-315K, key data from the sub-image features C_{i,j} 345, keys 410, key data of operation 615), at least one value (values 135A-135C), at least one attention tensor (e.g., attention scores 160A-160C, attention tensors 430, the query tensor of operation 610, the key tensor of operation 620), or a combination thereof. In some examples, the input data of the input layer 510 includes processed data that is to be processed further, such as various features, weights, intermediate data, or a combination thereof.

The neural network 500 includes multiple hidden layers 512, 512B, through 512N. The hidden layers 512, 512B, through 512N include “N” number of hidden layers, where “N” is an integer greater than or equal to one. The number of hidden layers can be made to include as many layers as needed for the given application. The neural network 500 further includes an output layer 514 that provides an output resulting from the processing performed by the hidden layers 512, 512B, through 512N.

In some examples, the output layer 514 can provide output data. The output data can include output tokens (e.g., output tokens 175A-175C), at least a portion of a context tensor 215 of FIG. 2, at least a portion of an output 225 of FIG. 2, or a combination thereof. In some examples, the output data can include at least a portion of a bird's-eye view of a scene (e.g., example 235, BEV 325A-325C). In some examples, the output data can include at least one attention tensor (e.g., attention scores 160A-160C, attention tensors 430, the query tensor of operation 610, the key tensor of operation 620).

The neural network 500 is a multi-layer neural network of interconnected filters. Each filter can be trained to learn a feature representative of the input data. Information associated with the filters is shared among the different layers and each layer retains information as information is processed. In some cases, the neural network 500 can include a feed-forward network, in which case there are no feedback connections where outputs of the network are fed back into itself. In some cases, the network 500 can include a recurrent neural network, which can have loops that allow information to be carried across nodes while reading in input.

In some cases, information can be exchanged between the layers through node-to-node interconnections between the various layers. In some cases, the network can include a convolutional neural network, which may not link every node in one layer to every other node in the next layer. In networks where information is exchanged between layers, nodes of the input layer 510 can activate a set of nodes in the first hidden layer 512A. For example, as shown, each of the input nodes of the input layer 510 can be connected to each of the nodes of the first hidden layer 512A. The nodes of a hidden layer can transform the information of each input node by applying activation functions (e.g., filters) to this information. The information derived from the transformation can then be passed to and can activate the nodes of the next hidden layer 512B, which can perform their own designated functions. Example functions include convolutional functions, downscaling, upscaling, data transformation, and/or any other suitable functions. The output of the hidden layer 512B can then activate nodes of the next hidden layer, and so on. The output of the last hidden layer 512N can activate one or more nodes of the output layer 514, which provides a processed output image. In some cases, while nodes (e.g., node 516) in the neural network 500 are shown as having multiple output lines, a node has a single output and all lines shown as being output from a node represent the same output value.

In some cases, each node or interconnection between nodes can have a weight that is a set of parameters derived from the training of the neural network 500. For example, an interconnection between nodes can represent a piece of information learned about the interconnected nodes. The interconnection can have a tunable numeric weight that can be tuned (e.g., based on a training dataset), allowing the neural network 500 to be adaptive to inputs and able to learn as more and more data is processed.

The neural network 500 is pre-trained to process the features from the data in the input layer 510 using the different hidden layers 512, 512B, through 512N in order to provide the output through the output layer 514.

FIG. 6 is a flow diagram illustrating a process 600 for attention calculation optimization. The process 600 for decoding may be performed by an attention calculation optimization system (e.g., a chipset, a processor or multiple processors such as an ISP, host processor, application processor, other processor, and/or other component). In some examples, the attention calculation optimization system can include, for example, the auto-regressive transformer model of FIG. 1, the weight tensor W_{Q} 110 for query projection of FIG. 1, the weight tensor W_{K} 120 for key projection of FIG. 1, the weight tensor W_{V} 130 for value projection of FIG. 1, the attention blocks 140A-140C of FIG. 1, the weight tensor Wₚᵣₒⱼ 170 for projection of FIG. 1, the system 200 of FIG. 2, the encoder 210 of FIG. 2, the decoder 220 of FIG. 2, the system 400 of FIG. 4, the group generation engine 415 of FIG. 4, the tensor multiplication engine(s) 420 of FIG. 4, the neural network 500, the computing system 700 of FIG. 7, one or more AI accelerators, a system, a computing system, an apparatus, a device, a non-transitory computer readable medium having stored thereon a program to be performed using a processor, a display, a communication transceiver, a communication interface, or a combination thereof.

At operation 605, the attention calculation optimization system (or component(s) thereof) is configured to, and can, identify tensor dimensions based on at least one characteristic (e.g., characteristic(s) 425) of a tensor multiplication engine (e.g., tensor multiplication engine 420).

In some examples, the tensor dimensions are matrix dimensions based on the at least one characteristic indicating that the tensor multiplication engine is optimized for matrix multiplication. In such examples, the at least one query tensor includes at least one query matrix, the at least one key tensor includes at least one key matrix, and the tensor multiplication is a matrix multiplication.

In some examples, the at least one characteristic of the tensor multiplication engine includes at least one of a core unit tensor size associated with the tensor multiplication engine, a memory size associated with a memory used by the tensor multiplication engine, a memory bandwidth associated with the memory used by the tensor multiplication engine, a rate of tensor multiplication calculations that the tensor multiplication engine can perform per unit of time, a numeric data type that the tensor multiplication engine uses for numbers within tensors multiplied using the tensor multiplication engine, or a combination thereof.

At operation 610, the attention calculation optimization system (or component(s) thereof) is configured to, and can, group (e.g., using the group generation engine 415) a subset of query data (e.g., queries 405) into at least one query tensor having the tensor dimensions. Examples of the at least one query tensor include the query 115A, the query 115B, the query 115C, the query Q 305A, the query Q 305B, the set of common queries Q_{L} 340, query tensor of the attention tensors 430, or another query tensor discussed herein). At operation 615, the attention calculation optimization system (or component(s) thereof) is configured to, and can, group (e.g., using the group generation engine 415) a subset of key data (e.g., keys 410) into at least one key tensor (e.g., key 125A, key 125B, key 125C, key tensor of the attention tensors 430) having the tensor dimensions.

In some examples, attention calculation optimization system (or component(s) thereof) is configured to, and can, select the subset of the query data for inclusion in the at least one query tensor based on the subset of the query data being associated with a plurality of query features that are proximate to one another in a scene according a first perspective of the scene. For instance, the subset of features 310B can include the projected location and an area in the proximity (e.g., within a radius of a predetermined size) around a projected location, and/or proximity to one another. The attention calculation optimization system can select the subset of the key data for inclusion in the at least one key tensor based on the subset of the key data being associated with a plurality of key features that are proximate to one another in the scene according a one or more perspectives of the scene.

In some examples, attention calculation optimization system (or component(s) thereof) is configured to, and can, select the subset of the query data for inclusion in the at least one query tensor based on use of at least one trained machine learning model that identifies at least one correlation within the subset of the query data. The attention calculation optimization system can select the subset of the key data for inclusion in the at least one key tensor based on use of the at least one trained machine learning model that identifies at least one correlation within the subset of the key data. In an illustrative example, keys C5, C10, and C15 can be selected based on having a high correlation with attention results A1, A7, and A16, respectively. The keys C5, C10, and C15 can be examples of three of the features 310A, three of the features 310B, three of the sub-image features C_{i,j} 345, and/or three of the keys 410. Attention results A1, A7, and A16 can be examples of the results of any of the attention blocks 140A-140C, the attention tensors 430, other attention results discussed herein, or a combination thereof.

In some examples, the key data is associated with image data of a scene captured using at least one camera (e.g., of the cameras 315A-315K) having at least one perspective, and the query data is associated with a generated view of the scene from a generated perspective (e.g., BEV 325A-325C) that is different from the at least one perspective of the at least one camera.

In some examples, the key data is associated with at least one feature (e.g., sub-image features C_{i,j} 345) within image data of a scene captured using at least one camera (e.g., of the cameras 315A-315K) having at least one perspective of the scene, and the query data is associated with the at least one feature within a generated view of the scene from a generated perspective of the scene (e.g., BEV 325A-325C) that is different from the at least one perspective of the at least one camera. In some examples, the generated perspective of the scene is a bird's eye view perspective of the scene (e.g., Example 235, BEV 325A-325C).

In some examples, the at least one query tensor includes at least a first query tensor and a second query tensor, and the first query tensor and the second query tensor share at least one overlapping element. In some examples, the at least one key tensor includes at least a first key tensor and a second key tensor, and the first key tensor and the second key tensor share at least one overlapping element.

In some examples, the query data (e.g., queries 115A-115C) is based on input data (e.g., input token 105A-105C), and the key data (e.g., keys 125A-125C) is based on the input data (e.g., input token 105A-105C).

In some examples, the key data identifies source data from at least one data source (e.g., the cameras 315A-315K), and the query data identifies at least one constraint (e.g., the perspective of the BEV 325A-325C) for generated content to be generated based on the source data. In some examples, the at least one data source includes at least one camera having at least one perspective of a scene, the source data includes image data captured by the at least one camera, the at least one constraint identifies a second perspective of the scene distinct from the at least one perspective of the scene, and the generated content is a generated image of the scene from the second perspective. In some examples, the second perspective is a bird's eye view perspective (e.g., Example 235, BEV 325A-325C).

At operation 620, the attention calculation optimization system (or component(s) thereof) is configured to, and can, determine, using the tensor multiplication engine, a tensor multiplication including the at least one query tensor and the at least one key tensor to generate output data (e.g., the interim activation 165A-165C, the output token 175A-175C, the output 225).

In some examples, the attention calculation optimization system (or component(s) thereof) is configured to, and can, multiply the at least one query tensor by the at least one key tensor to generate an attention tensor (e.g., one of the attention scores 160A-160C), and multiply the attention tensor by a value tensor (e.g., one of the values 135A-135C or a tensor derived therefrom) to generate the output data (e.g, one of the interim activations 165A-165C, one of the output tokens 175A-175C). In some examples, the attention tensor has the tensor dimensions. In some examples, the value tensor has the tensor dimensions. In some examples, the attention calculation optimization system (or component(s) thereof) is configured to, and can, process the attention tensor (e.g., using the scaling factor dₖ 145, one of the masks 150A-150C, and/or the softmax function a 155) before multiplying the attention tensor by the value tensor. In some examples, the attention calculation optimization system (or component(s) thereof) is configured to, and can, process the output data (e.g., one of the interim activations 165A-165C) (e.g., using the weight tensor Wₚᵣₒⱼ 170 for projection) to generate an output token (e.g., one of the output tokens 175A-175C, the output 225).

In some examples, the processes described herein (e.g., the process of FIG. 1, the process of FIG. 2, the processes 300A-300C of FIGS. 3A-3C, the process of FIG. 4, the process of FIG. 5, the process 600 of FIG. 6, and/or other processes described herein) may be performed by a computing device or apparatus. In some examples, the processes described herein can be performed by the auto-regressive transformer model of FIG. 1, the weight tensor W_{Q} 110 for query projection of FIG. 1, the weight tensor W_{K} 120 for key projection of FIG. 1, the weight tensor W_{V} 130 for value projection of FIG. 1, the attention blocks 140A-140C of FIG. 1, the weight tensor Wₚᵣₒⱼ 170 for projection of FIG. 1, the system 200 of FIG. 2, the encoder 210 of FIG. 2, the decoder 220 of FIG. 2, the system 400 of FIG. 4, the group generation engine 415 of FIG. 4, the tensor multiplication engine(s) 420 of FIG. 4, the neural network 500, the attention calculation optimization system that performs the process 600 of FIG. 6, the computing system 700 of FIG. 7, the processor 710, a system, and apparatus, a device, a non-transitory computer readable medium having stored thereon a program to be performed using a processor, or a combination thereof. In some examples, the imaging system includes a display. In some examples, the imaging system includes a transceiver and/or other communication interface(s).

The computing device can include any suitable device, such as a mobile device (e.g., a mobile phone), a desktop computing device, a tablet computing device, a wearable device (e.g., a VR headset, an AR headset, AR glasses, a network-connected watch or smartwatch, or other wearable device), a server computer, a vehicle or computing device of a vehicle, a robotic device, a television, and/or any other computing device with the resource capabilities to perform the processes described herein. In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, a network interface configured to communicate and/or receive the data, any combination thereof, and/or other component(s). The network interface may be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

The processes described herein are illustrated as logical flow diagrams, block diagrams, or conceptual diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 7 is a diagram illustrating an example of a system for implementing certain aspects of the present technology. In particular, FIG. 7 illustrates an example of computing system 700, which can be for example any computing device making up internal computing system, a remote computing system, a camera, or any component thereof in which the components of the system are in communication with each other using connection 705. Connection 705 can be a physical connection using a bus, or a direct connection into processor 710, such as in a chipset architecture. Connection 705 can also be a virtual connection, networked connection, or logical connection.

In some aspects, computing system 700 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 700 includes at least one processor 810, such as a central processing unit (CPU), graphics processing unit (GPU), neural processing unit (NPU), digital signal processor (DSP), image signal processor (ISP), a field programmable gate array (FPGA), an application specific integrated circuit (ASIC), a microprocessor, a controller, another type of processing unit, another suitable electronic circuit, or a combination thereof. The computing system 800 also includes a connection 705 that couples various system components including system memory 715, such as read-only memory (ROM) 720 and random access memory (RAM) 725 to processor 710. Computing system 700 can include a cache 712 of high-speed memory connected directly with, in close proximity to, or integrated as part of processor 710.

Processor 710 can include any general purpose processor and a hardware service or software service, such as services 732, 734, and 736 stored in storage device 730, configured to control processor 710 as well as a special-purpose processor where software instructions are incorporated into the actual processor design. Processor 710 may essentially be a completely self-contained computing system, containing multiple cores or processors, a bus, memory controller, cache, etc. A multi-core processor may be symmetric or asymmetric.

To enable user interaction, computing system 700 includes an input device 745, which can represent any number of input mechanisms, such as a microphone for speech, a touch-sensitive screen for gesture or graphical input, keyboard, mouse, motion input, speech, etc. Computing system 700 can also include output device 735, which can be one or more of a number of output mechanisms. In some instances, multimodal systems can enable a user to provide multiple types of input/output to communicate with computing system 700. Computing system 700 can include communications interface 740, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 702.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 740 may also include one or more Global Navigation Satellite System (GNSS) receivers or transceivers that are used to determine a location of the computing system 700 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 730 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 730 can include software services, servers, services, etc., that when the code that defines such software is executed by the processor 710, it causes the system to perform a function. In some aspects, a hardware service that performs a particular function can include the software component stored in a computer-readable medium in connection with the necessary hardware components, such as processor 710, connection 705, output device 735, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, or the like.

In some aspects, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“<”) and greater than or equal to (“>”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” means A, B, or A and B. In another example, claim language reciting “at least one of A, B, and C” means A, B, C, or A and B, or A and C, or B and C, or A and B and C. The language “at least one of” a set and/or “one or more” of a set does not limit the set to the items listed in the set. For example, claim language reciting “at least one of A and B” can mean A, B, or A and B, and can additionally include items not listed in the set of A and B.

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Claim language or other language reciting “at least one processor configured to,” “at least one processor being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Illustrative aspects of the disclosure include:

Aspect 1. An apparatus for cached decoding, the apparatus comprising: a memory; and at least one processor (e.g., implemented in circuitry) coupled to the memory and configured to: identify tensor dimensions based on at least one characteristic of a tensor multiplication engine; group a subset of query data into at least one query tensor having the tensor dimensions; group a subset of key data into at least one key tensor having the tensor dimensions; and determine, using the tensor multiplication engine, a tensor multiplication including the at least one query tensor and the at least one key tensor to generate output data.

Aspect 2. The apparatus of Aspect 1, wherein the tensor dimensions are matrix dimensions based on the at least one characteristic indicating that the tensor multiplication engine is optimized for matrix multiplication, wherein the at least one query tensor includes at least one query matrix, wherein the at least one key tensor includes at least one key matrix, and wherein the tensor multiplication is a matrix multiplication.

Aspect 3. The apparatus of any of Aspects 1 to 2, wherein the at least one processor is configured to: select the subset of the query data for inclusion in the at least one query tensor based on the subset of the query data being associated with a plurality of query features that are proximate to one another in a scene according a first perspective of the scene; and select the subset of the key data for inclusion in the at least one key tensor based on the subset of the key data being associated with a plurality of key features that are proximate to one another in the scene according a one or more perspectives of the scene.

Aspect 4. The apparatus of any of Aspects 1 to 3, wherein the at least one processor is configured to: select the subset of the query data for inclusion in the at least one query tensor based on use of at least one trained machine learning model that identifies at least one correlation within the subset of the query data; and select the subset of the key data for inclusion in the at least one key tensor based on use of the at least one trained machine learning model that identifies at least one correlation within the subset of the key data.

Aspect 5. The apparatus of any of Aspects 1 to 4, wherein the at least one processor is configured to: select the subset of the query data for inclusion in the at least one query tensor based on use of at least one trained machine learning model that identifies at least one correlation within the subset of the query data; and select the subset of the key data for inclusion in the at least one key tensor based on use of the at least one trained machine learning model that identifies at least one correlation within the subset of the key data.

Aspect 6. The apparatus of any of Aspects 1 to 5, wherein the at least one characteristic of the tensor multiplication engine includes at least one of a core unit tensor size associated with the tensor multiplication engine, a memory size associated with a memory used by the tensor multiplication engine, a memory bandwidth associated with the memory used by the tensor multiplication engine, a rate of tensor multiplication calculations that the tensor multiplication engine can perform per unit of time, or a numeric data type that the tensor multiplication engine uses for numbers within tensors multiplied using the tensor multiplication engine.

Aspect 7. The apparatus of any of Aspects 1 to 6, wherein the key data is associated with image data of a scene captured using at least one camera having at least one perspective, and wherein the query data is associated with a generated view of the scene from a generated perspective that is different from the at least one perspective of the at least one camera.

Aspect 8. The apparatus of any of Aspects 1 to 7, wherein the key data is associated with at least one feature within image data of a scene captured using at least one camera having at least one perspective of the scene, and wherein the query data is associated with the at least one feature within a generated view of the scene from a generated perspective of the scene that is different from the at least one perspective of the at least one camera.

Aspect 9. The apparatus of Aspect 8, wherein the generated perspective of the scene is a bird's eye view perspective of the scene.

Aspect 10. The apparatus of any of Aspects 1 to 9, wherein the at least one query tensor includes at least a first query tensor and a second query tensor, wherein the first query tensor and the second query tensor share at least one overlapping element.

Aspect 11. The apparatus of any of Aspects 1 to 10, wherein the at least one key tensor includes at least a first key tensor and a second key tensor, wherein the first key tensor and the second key tensor share at least one overlapping element.

Aspect 12. The apparatus of any of Aspects 1 to 11, wherein the query data is based on input data, and wherein the key data is based on the input data.

Aspect 13. The apparatus of any of Aspects 1 to 12, wherein the key data identifies source data from at least one data source, wherein the query data identifies at least one constraint for generated content to be generated based on the source data.

Aspect 14. The apparatus of Aspect 13, wherein the at least one data source includes at least one camera having at least one perspective of a scene, wherein the source data includes image data captured by the at least one camera, wherein the at least one constraint identifies a second perspective of the scene distinct from the at least one perspective of the scene, and wherein the generated content is a generated image of the scene from the second perspective.

Aspect 15. The apparatus of Aspect 14, wherein the second perspective is a bird's eye view perspective.

Aspect 16. The apparatus of any of Aspects 1 to 15, wherein the at least one processor is configured to: multiply the at least one query tensor by the at least one key tensor to generate an attention tensor; and multiply the attention tensor by a value tensor to generate the output data.

Aspect 17. The apparatus of Aspect 16, wherein the attention tensor has the tensor dimensions.

Aspect 18. The apparatus of any of Aspects 16 to 17, wherein the value tensor has the tensor dimensions.

Aspect 19. The apparatus of any of Aspects 16 to 18, wherein the at least one processor is configured to: process the attention tensor before multiplying the attention tensor by the value tensor.

Aspect 20. The apparatus of any of Aspects 16 to 19, wherein the at least one processor is configured to: process the output data to generate an output token.

Aspect 21. A method for attention calculation, the method comprising: identifying tensor dimensions based on at least one characteristic of a tensor multiplication engine; grouping a subset of query data into at least one query tensor having the tensor dimensions; grouping a subset of key data into at least one key tensor having the tensor dimensions; and determining, using the tensor multiplication engine, a tensor multiplication including the at least one query tensor and the at least one key tensor to generate output data.

Aspect 22. The method of Aspect 21, wherein the tensor dimensions are matrix dimensions based on the at least one characteristic indicating that the tensor multiplication engine is optimized for matrix multiplication, wherein the at least one query tensor includes at least one query matrix, wherein the at least one key tensor includes at least one key matrix, and wherein the tensor multiplication is a matrix multiplication.

Aspect 23. The method of any of Aspects 21 to 22, further comprising: selecting the subset of the query data for inclusion in the at least one query tensor based on the subset of the query data being associated with a plurality of query features that are proximate to one another in a scene according a first perspective of the scene; and selecting the subset of the key data for inclusion in the at least one key tensor based on the subset of the key data being associated with a plurality of key features that are proximate to one another in the scene according a one or more perspectives of the scene.

Aspect 24. The method of any of Aspects 21 to 23, further comprising: selecting the subset of the query data for inclusion in the at least one query tensor based on use of at least one trained machine learning model that identifies at least one correlation within the subset of the query data; and selecting the subset of the key data for inclusion in the at least one key tensor based on use of the at least one trained machine learning model that identifies at least one correlation within the subset of the key data.

Aspect 25. The method of any of Aspects 21 to 24, further comprising: selecting the subset of the query data for inclusion in the at least one query tensor based on use of at least one trained machine learning model that identifies at least one correlation within the subset of the query data; and selecting the subset of the key data for inclusion in the at least one key tensor based on use of the at least one trained machine learning model that identifies at least one correlation within the subset of the key data.

Aspect 26. The method of any of Aspects 21 to 25, wherein the at least one characteristic of the tensor multiplication engine includes at least one of a core unit tensor size associated with the tensor multiplication engine, a memory size associated with a memory used by the tensor multiplication engine, a memory bandwidth associated with the memory used by the tensor multiplication engine, a rate of tensor multiplication calculations that the tensor multiplication engine can perform per unit of time, or a numeric data type that the tensor multiplication engine uses for numbers within tensors multiplied using the tensor multiplication engine.

Aspect 27. The method of any of Aspects 21 to 26, wherein the key data is associated with image data of a scene captured using at least one camera having at least one perspective, and wherein the query data is associated with a generated view of the scene from a generated perspective that is different from the at least one perspective of the at least one camera.

Aspect 28. The method of any of Aspects 21 to 27, wherein the key data is associated with at least one feature within image data of a scene captured using at least one camera having at least one perspective of the scene, and wherein the query data is associated with the at least one feature within a generated view of the scene from a generated perspective of the scene that is different from the at least one perspective of the at least one camera.

Aspect 29. The method of any of Aspects 21 to 28, wherein the at least one query tensor includes at least a first query tensor and a second query tensor, wherein the first query tensor and the second query tensor share at least one overlapping element.

Aspect 30. The method of any of Aspects 21 to 29, further comprising: multiplying the at least one query tensor by the at least one key tensor to generate an attention tensor; and multiplying the attention tensor by a value tensor to generate the output data.

Aspect 31. A non-transitory computer-readable medium having stored thereon instructions that, when executed by one or more processors, cause the one or more processors to perform operations according to any of Aspects 1 to 30.

Aspect 32. An apparatus for imaging, the apparatus comprising one or more means for performing operations according to any of Aspects 1 to 30.

What is claimed is:

1. An apparatus for attention calculation, the apparatus comprising:
at least one memory; and
at least one processor coupled to the at least one memory and configured to:
identify tensor dimensions based on at least one characteristic of a tensor multiplication engine;
group a subset of query data into at least one query tensor having the tensor dimensions;
group a subset of key data into at least one key tensor having the tensor dimensions; and
determine, using the tensor multiplication engine, a tensor multiplication including the at least one query tensor and the at least one key tensor to generate output data.

2. The apparatus of claim 1, wherein the tensor dimensions are matrix dimensions based on the at least one characteristic indicating that the tensor multiplication engine is optimized for matrix multiplication, wherein the at least one query tensor includes at least one query matrix, wherein the at least one key tensor includes at least one key matrix, and wherein the tensor multiplication is a matrix multiplication.

3. The apparatus of claim 1, wherein the at least one processor is configured to:
select the subset of the query data for inclusion in the at least one query tensor based on the subset of the query data being associated with a plurality of query features that are proximate to one another in a scene according a first perspective of the scene; and
select the subset of the key data for inclusion in the at least one key tensor based on the subset of the key data being associated with a plurality of key features that are proximate to one another in the scene according a one or more perspectives of the scene.

4. The apparatus of claim 1, wherein the at least one processor is configured to:
select the subset of the query data for inclusion in the at least one query tensor based on use of at least one trained machine learning model that identifies at least one correlation within the subset of the query data; and
select the subset of the key data for inclusion in the at least one key tensor based on use of the at least one trained machine learning model that identifies at least one correlation within the subset of the key data.

5. The apparatus of claim 1, wherein the at least one characteristic of the tensor multiplication engine includes at least one of a core unit tensor size associated with the tensor multiplication engine, a memory size associated with a memory used by the tensor multiplication engine, a memory bandwidth associated with the memory used by the tensor multiplication engine, a rate of tensor multiplication calculations that the tensor multiplication engine can perform per unit of time, or a numeric data type that the tensor multiplication engine uses for numbers within tensors multiplied using the tensor multiplication engine.

6. The apparatus of claim 1, wherein the key data is associated with image data of a scene captured using at least one camera having at least one perspective, and wherein the query data is associated with a generated view of the scene from a generated perspective that is different from the at least one perspective of the at least one camera.

7. The apparatus of claim 1, wherein the key data is associated with at least one feature within image data of a scene captured using at least one camera having at least one perspective of the scene, and wherein the query data is associated with the at least one feature within a generated view of the scene from a generated perspective of the scene that is different from the at least one perspective of the at least one camera.

8. The apparatus of claim 7, wherein the generated perspective of the scene is a bird's eye view perspective of the scene.

9. The apparatus of claim 1, wherein the at least one query tensor includes at least a first query tensor and a second query tensor, wherein the first query tensor and the second query tensor share at least one overlapping element.

10. The apparatus of claim 1, wherein the at least one key tensor includes at least a first key tensor and a second key tensor, wherein the first key tensor and the second key tensor share at least one overlapping element.

11. The apparatus of claim 1, wherein the query data is based on input data, and wherein the key data is based on the input data.

12. The apparatus of claim 1, wherein the key data identifies source data from at least one data source, wherein the query data identifies at least one constraint for generated content to be generated based on the source data.

13. The apparatus of claim 12, wherein the at least one data source includes at least one camera having at least one perspective of a scene, wherein the source data includes image data captured by the at least one camera, wherein the at least one constraint identifies a second perspective of the scene distinct from the at least one perspective of the scene, and wherein the generated content is a generated image of the scene from the second perspective.

14. The apparatus of claim 13, wherein the second perspective is a bird's eye view perspective.

15. The apparatus of claim 1, wherein the at least one processor is configured to:
multiply the at least one query tensor by the at least one key tensor to generate an attention tensor; and
multiply the attention tensor by a value tensor to generate the output data.

16. The apparatus of claim 15, wherein the attention tensor has the tensor dimensions.

17. The apparatus of claim 15, wherein the value tensor has the tensor dimensions.

18. The apparatus of claim 15, wherein the at least one processor is configured to:
process the attention tensor before multiplying the attention tensor by the value tensor.

19. The apparatus of claim 15, wherein the at least one processor is configured to:
process the output data to generate an output token.

20. A method for attention calculation, the method comprising:
identifying tensor dimensions based on at least one characteristic of a tensor multiplication engine;
grouping a subset of query data into at least one query tensor having the tensor dimensions;
grouping a subset of key data into at least one key tensor having the tensor dimensions; and
determining, using the tensor multiplication engine, a tensor multiplication including the at least one query tensor and the at least one key tensor to generate output data.
